(19) United States
(12) Patent Application Publication
(10) Pub. No.: US 2018/0196894 A1
(43) Pub. Date: Jul. 12, 2018

(54) SYSTEM AND METHOD FOR MONITORING A STEAM TURBINE AND PRODUCING ADAPTED INSPECTION INTERVALS

(71) Applicant: General Electric Company, Schenectady, NY (US)

(72) Inventors: Leonidas VENEDIKIS, Baden (CH); Frank LEIDICH, Mannheim (DE)

(21) Appl. No.: 15/402,708

(22) Filed: Jan. 10, 2017

(51) Int. Cl. G06F 17/50; F01K 13/00

(52) U.S. Cl. CPC G06F 17/5009; F01K 13/003

(57) ABSTRACT

A system and method for monitoring the operating conditions of a steam turbine and developing an adaptive inspection interval includes access to a digital data storage archive containing information relating to use and operation of comparable steam turbines and plant/service events, one or more turbine operational condition sensors for monitoring steam quality in real time during operation of the steam turbine. A processor calculates a steam quality value based upon cation conductivity of the steam used to operate the steam turbine as measured by the sensors. The processor uses the calculated steam quality information either alone or together with other acquired operational and parametric data to determine an adapted inspection interval for the steam turbine. The processor produces an output which includes the determined adapted inspection interval and may additionally include updated maintenance and repair schedules. A method for adapting an inspection interval for a particular steam turbine at a particular plant involves considering a calculated steam quality of the steam provided to the turbine, considering any available corrosion diagnostics data obtained during any turbine stand-still lay-off times, considering any relevant turbine fleet information and historical plant/service event information, and evaluating these parameters and informations to determine an adapted maintenance interval for the steam turbine. The method includes calculating a steam quality value in accordance with a predetermined formula based on a real-time measured conductivity of the steam provided to the turbine during operation and generating a output specifying an inspection interval adapted to the particular steam turbine and plant of operation.

### BACKGROUND OF THE INVENTION

The present invention relates generally to a system and method for monitoring the operational conditions of a steam turbine and developing adaptive inspection intervals. More specifically, the present invention describes a system and method that develops customized steam turbine inspection/maintenance interval recommendations based upon one or more of steam quality assessment data acquired and calculated in real-time during actual plant operations of an individual steam turbine, relevant corrosion level diagnostics performed upon the steam turbine during a stand-still condition, and historical plant/service event digital database information to adapt a conventionally prescribed fleet inspection/maintenance interval of a particular steam turbine to specific plant operational conditions.

Steam turbines are widely used in industrial and commercial operations. As shown in FIG. 1, a typical steam turbine system 10 includes a high pressure (HP) section 15, an intermediate pressure (TP) section 20, and a low pressure (LP) section 25. The sections 15, 20, 25 may be positioned on a rotor 30 for rotation therewith. The section 15, 20, 25 may drive the rotor 30 and a load 35 such as an electrical generator and the like. A flow of steam 40 may enter the HP section 15 from a boiler, a steam generator, and the like. The flow of steam 40 may pass through the HP section 15 producing useful work therein and then exit towards a repeater and the like. The flow of steam 40 then may be introduced into the IP section 20 to produce useful work therein. The process then may be repeated for the LP section 25. Other components and other configurations may also be used.

Steam turbines, like any other mechanical device, require periodic repairs and maintenance to ensure proper operation. As a general approach, previous experiences with the “fleet” of steam turbines, i.e., particularly comparable steam turbines of similar class or type, may be statistically analyzed to develop a “fleet model” that can be used to predict the anticipated wear and damage experienced by other steam turbines. Based on the fleet model, projections, repairs, inspections and maintenance can be scheduled at optimum intervals that minimize the risk of both unplanned shutdowns to effect repairs and also unnecessary shutdowns to perform unneeded preventive maintenance.

The actual performance of individual steam turbines, however, may vary from the fleet model. For example, individual steam turbines may have slight differences in configuration, manufacturing tolerances, and assembly that can result in different levels of wear and damage compared to the fleet model. In addition, the operational conditions, repair, and maintenance that individual steam turbines actually experience may differ from the fleet average. For example, steam turbines operated in adverse environments or with poor quality corrosive steam may require more frequent inspections, repairs and maintenance to address issues associated with corrosion, pitting, and emissions compared to the fleet model. Conversely, other steam turbines that are operated under optimal conditions and using good quality steam may experience fewer startups and/or shutdown cycles and, therefore, would require less frequent shutdowns to perform inspections and preventive maintenance associated with cyclical stresses as compared to the fleet model standard. Conventionally, however, a fixed inspection/maintenance interval for a particular steam turbine is developed according to a fleet model formula and is then prescribed for a plant regardless of the particular plant operational conditions for the turbine. For example, steam turbine inspection recommendations for a particular turbine fleet are typically derived from a fixed formula for total EOH (effective hours of operation) that is calculated using a factor based on number of turbine starts and logged hours of operating time. Consequently, there is little or no flexibility for an individual plant regarding scheduling of inspections and maintenance shutdown times that result in system unavailability. Actual real-time measured operational conditions of a steam turbine in situ at a particular plant are conventionally not obtained or considered in determining an inspection/maintenance interval for a steam turbine. Likewise, historical service events/records and turbine corrosion inspection findings at a particular plant are rarely if ever considered in determining the inspection/maintenance interval for a particular turbine. In particular, there is no consideration of operations at individual plants which may be using a higher quality steam and/or have low corrosion and which, therefore, require less maintenance and would benefit economically from an extended inspection interval. A similar consideration applies for steam turbines in plants operated with poor quality steam and/or under adverse conditions which may require more maintenance and should have inspections conducted at intervals shorter than the prescribed fixed-interval fleet formula.

Therefore, an improved system and method for monitoring the real-time operational conditions of a steam turbine and adapting or determining an inspection interval that is specific to individual plant operational conditions would be desirable.

### BRIEF DESCRIPTION AND SUMMARY OF THE INVENTION

A described system and method allows for a prescribed inspection interval for a steam turbine to be adapted based upon specific plant actual operational conditions and real-time operational data associated with individual steam turbines. This approach allows for extended inspection intervals for plants that use high quality steam and exhibit good operational behaviors. It also provides an ability to customize or modify a fleet prescribed interval/schedule for conducting inspections, maintenance and repairs based on individual plant/turbine operational conditions.

One non-limiting example embodiment of the present invention is a method for adapting a fleet prescribed inspection interval for a steam turbine based upon an operational profile developed from real-time monitored operational parameters. The method includes obtaining real-time measurements of one or more operational conditions/parameters of the steam turbine during its service in operation and calculating an operational profile quality value. The calculated operational profile value is then used to determine an adapted inspection interval or may be further evaluated along with obtained historical plant/service event information regarding the steam turbine and/or other obtained diagnostic information concerning the current condition of the steam turbine. For example, the method may include using a cold end corrosion diagnostic of the steam turbine for determining existing corrosion levels as other obtained diagnostic information.

Another non-limiting example embodiment of the present invention is a method for monitoring the operating environment and/or the operational conditions of a particular steam turbine in service at a particular plant and includes receiving or accessing data from a database containing plant/service event information relating to the steam turbine, measuring steam conductivity as an indicator of corrosive content of the steam and calculating a steam quality value, performing/obtaining stand-still corrosion diagnostics of the turbine (e.g., cold end corrosion diagnostic) and evaluating the combined information to develop an adapted/modified inspection interval and/or schedule for maintenance. The method includes calculating a steam quality value based upon steam conductivity (i.e., cation content) measured in-situ in real-time. The method may also include evaluating the steam quality value along with other operational parameters and/or obtained historical plant/service event information and/or obtained corrosion diagnostic information. The method may further include generating an output signal/information containing at least one of an operational quality valuation, an expected condition forecast for the steam turbine and an inspection/maintenance interval schedule.

A still further non-limiting example embodiment of the present invention is a system for monitoring the operating environment and/or the operational conditions of a steam turbine in service at a particular plant and generating inspection interval schedule information for the turbine. The system includes at least a processor, an I/O interface, one or more turbine steam conductivity sensors, and a memory element containing a database of at least historical plant/service event information for the turbine, wherein the I/O interface accepts one or more sensor signal indicative of steam conductivity obtained at one or more steam inlets of the steam turbine. It should be noted, however, that the invention disclosed herein is not limited solely to the use of steam conductivity as a measurable parameter indicative of the steam quality or “salt impact”. For example, steam conductivity could be replaced by ion chromatography using a sensor that measures Chloride and Sulfate concentrations in the ppb range. Using data based on Chloride and Sulfate concentrations, a steam conductivity may be calculated or, alternatively, the chloride/sulfate concentrations themselves may be used to determine a steam quality value. The processor being in communication with the memory element and performing a calculation in real-time indicative of the steam quality provided to the turbine, the calculated steam quality being used alone or in conjunction with obtained historical plant/service information regarding the steam turbine and/or one or more turbine operational condition factors to develop, adapt or modify an inspection/maintenance interval schedule for the steam turbine. An output information/signal generated by the processor may include at least one of an operational quality valuation, an expected condition forecast for the steam turbine and an inspection/maintenance interval schedule for display or printing via the I/O interface.

Those of ordinary skill in the art will better appreciate the features and aspects of the above example embodiments, and others, upon review of the description and specifications disclosed herein.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a simplified schematic diagram of an exemplary steam turbine system;

FIG. 2 is a functional block diagram of a system for developing an adapted inspection interval for a monitored steam turbine in service under operating conditions at a plant according to one non-limiting example embodiment;

FIG. 3 is a schematic diagram of a steam turbine under service illustrating an example arrangement for locations of steam conductivity sensors;

FIG. 4 is a non-limiting example processor-implemented process flow chart for calculating a steam quality value and determining an adapted inspection interval;

FIG. 5 is a basic functional block diagram of the method for developing an adapted inspection interval of a steam turbine in accordance with one non-limiting example embodiment; and

FIG. 6 is a diagram of a low pressure end section of a steam turbine depicting sensor placement for an example CECD system.

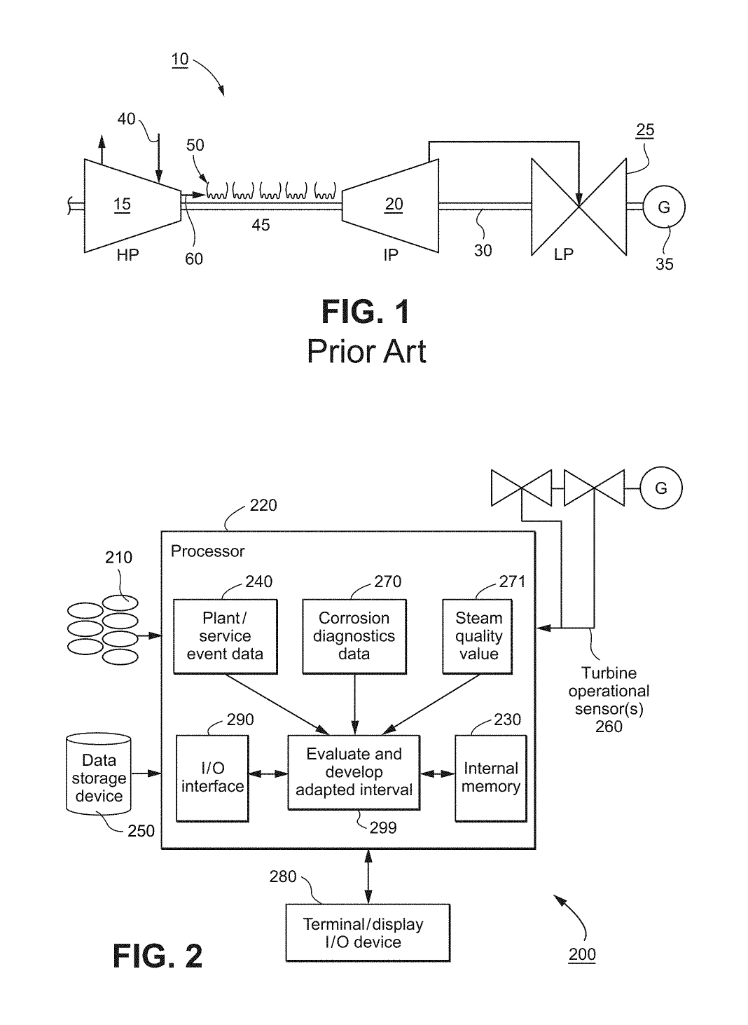

### DETAILED DESCRIPTION OF THE INVENTION

Reference will now be made in detail to non-limiting example embodiments of the invention which are illustrated in the accompanying drawings. Each example is provided by way of explanation of the invention, not limitation of the invention. It will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The system and method discussed herein may make reference to processors, servers, memories, databases, software applications, and/or other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among the components. For instance, computer-implemented processes discussed herein may be implemented using a single server or processor or multiple such elements working in combination. Databases and other memory/media elements and applications may be implemented on a single system or distributed across multiple systems. Distributed components may operate sequentially or in parallel. All such variations as will be understood by those of ordinary skill in the art are intended to come within the spirit and scope of the present subject matter.

When data is obtained or accessed between a first and second computer system, processing device, or component thereof, the actual data may travel between the systems directly or indirectly. For example, if a first computer accesses a file or data from a second computer, the access may involve one or more intermediary computers, proxies, or the like. The actual file or data may move between the computers, or one computer may provide a pointer or metafile that the second computer uses to access the actual data from a computer other than the first computer.

The various computer system(s) discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality, either complementary or unrelated to the present subject matter. For instance, one or more computing devices may be adapted to provide the described functionality by accessing software instructions rendered in a computer-readable form. When software is used, any suitable programming, scripting, or other type of language or combinations of languages may be used to implement the teachings contained herein. However, software need not be used exclusively, or at all. For example, as will be understood by those of ordinary skill in the art without required additional detailed discussion, some embodiments of the methods and systems set forth and disclosed herein may also be implemented by hard-wired logic or other circuitry, including, but not limited to application specific circuits. Of course, various combinations of computer-executed software and hard-wired logic or other circuitry may be suitable, as well.

It is to be understood by those of ordinary skill in the art that embodiments of the methods disclosed herein may be executed by one or more suitable computing devices that render the device(s) operative to implement such methods. As noted above, such devices may access one or more computer readable media that embody computer-readable instructions which, when executed by at least one computer, cause the at least one computer to implement one or more embodiments of the methods of the present subject matter. Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other solid-state memory devices, and the like.

The example methods and system described herein allows for a prescribed inspection/maintenance interval for an individual steam turbine to be adapted based upon specific real-time measured/monitored plant operational conditions, such as ongoing steam quality, and/or other known operation effecting conditions and event data associated with the individual steam turbine. Adapting an inspection/maintenance interval of a steam turbine on an individual basis according to specific plant operational conditions results in numerous benefits for a plant operator/customer such as extending turbine availability, providing greater operational flexibility and reducing unnecessary shutdowns, thereby improving the economics of operation over the life of the steam turbine.

As an example, if analysis of the unit specific data for operation of a particular steam turbine at a specific plant indicates a low wear and low likelihood of corrosive damage under the ongoing operational conditions, the availability of that particular steam turbine may be increased by extending the fixed/static inspection intervals conventionally prescribed in accordance with a fleet model formula. Conversely, if analyzed unit specific data for a particular steam turbine at a specific plant indicates greater wear/corrosion or an increased potential for corrosive damage due to the operational conditions at the specific plant, the fixed/static interval prescribed by the fleet model formula may be decreased, resulting in planned outages occurring at shorter intervals. In either case, the ability to have adjustable inspection/maintenance intervals based upon specific plant operational conditions will result in enhanced operational flexibility and improves the costs of operation throughout the useful life of the steam turbine.

FIG. 2 illustrates a functional block schematic diagram of a system 200 for developing an adapted inspection interval for a monitored steam turbine in service under operating conditions at a plant according to one non-limiting embodiment of the present invention. For the purposes of the present discussion, the term “steam turbine in service” or “under service” refers to a particular steam turbine 10 in service at a particular plant, as distinguished from a manufacturer's general commercial fleet of steam turbines. The system 200 may include access to an archival database 210 at a remote computer system (not depicted) containing digital historical plant/service event information for steam turbines at one or more steam turbine plants. The system 200 further includes a processor 220 that includes programming to access one or more external and internal memory/media elements 210, 230 or 250 via an I/O interface 290.

The processor 220 discussed herein is not limited to any particular hardware architecture or configuration. Instead, the processor 220 may comprise a general-purpose or customized computing device adapted to provide the described functionality by accessing memory media (e.g., blocks 36, 38, and/or 40), databases, and other hardware as directed by software instructions rendered in a computer-readable form or programmed circuitry. For example, the processor 220 may comprise a single server, a single micro-processor, hardwired logic, including, but not limited to, application-specific circuits, or multiple such elements working in combination.

In one example implementation, processor 220 is configured to retrieve and receive fleet model information signals and/or historical plant/service event signals 240 from database 210 to obtain or store relevant turbine information and data. For the purposes of the present discussion, the term “signals” refers to any electrical transmission of information. The fleet model and plant/service event information 240 may comprise, for example, data for comparable steam turbines projected by a fleet model and/or historical plant/service event information for a particular steam turbine at a particular plant. System 200 may also include a plant-based storage memory device 250 and processor 220 may contain internal data storage memory 230 for storage of turbine operational information, data and signals.

The database 210 discussed herein contains historical parameter information of the “fleet” of steam turbines, particularly comparable steam turbines of similar class or type, accumulated from available sources. The database 210 may include memory/media elements and applications implemented on a single system or distributed across multiple systems. If distributed components are used, they may operate sequentially or in parallel.

The historical parameter information contained in database 210 includes data reflecting operation, repairs, and/or maintenance of the comparable steam turbines. This historical parameter information may include data referred to as exposure data and damage data. Exposure data includes any information describing the operational history of a comparable steam turbine that can be statistically associated with predicting a failure mode or mechanism. For example, exposure data may include operating hours, number of start-up and shut-down cycles, steam temperatures, and number of unplanned trips. Damage data includes any hardware failure mechanisms that have occurred with a statistical significance. A failure mechanism includes any degradation in the physical or functional characteristics from the nominal values that results in a loss of output, loss of efficiency, or inability to operate the comparable steam turbine. Examples of known failure mechanisms include corrosion, creep, deformation, fatigue, foreign object damage, oxidation, plugging/contamination, rupture, and wear. These failure mechanisms may be collected or recorded as a result of enhanced boroscope inspections, onsite monitoring, operating logs, repair logs, maintenance logs, and the like.

The available sources of historical information include, for example, databases of operating experiences, operating records, part inspection records, and field inspection reports. Examples of the historical information included in these sources include, but are not limited to, enhanced boroscope inspection (EBI) reports, phased array ultrasonic inspections, electronic records, monitoring and diagnostics (M&D) data, records of outage events, operating hours, starts, and trips, and service shop or repair data. The collection of the historical information, such as exposure and damage data, is statistically analyzed and normalized to develop the fleet model, also known as a data accumulation model. The fleet model projects parameter information such as the growth of damage during future exposures using the collected historical information, and the fleet model and/or the projected parameter information may be communicated to the processor 220, for example, via the Internet or other wired or wireless communications network.

Processor 220 is also configured to receive signals from one or more turbine operational condition sensors 260 used in monitoring ongoing operating conditions and/or parameters of a steam turbine at a plant and to receive user-inputted command and control signals from a local terminal device 280 via I/O interface 290. Processor 220 may utilize internal digital data storage memory device 230 for storage of operational condition sensor signals and/or may utilize an external or local plant-based digital data storage device 250 for storage and retrieval of digital information and signals. Acquisition of data signals and communications to processor 220 are handled by known conventional processes via processor I/O interface 290.

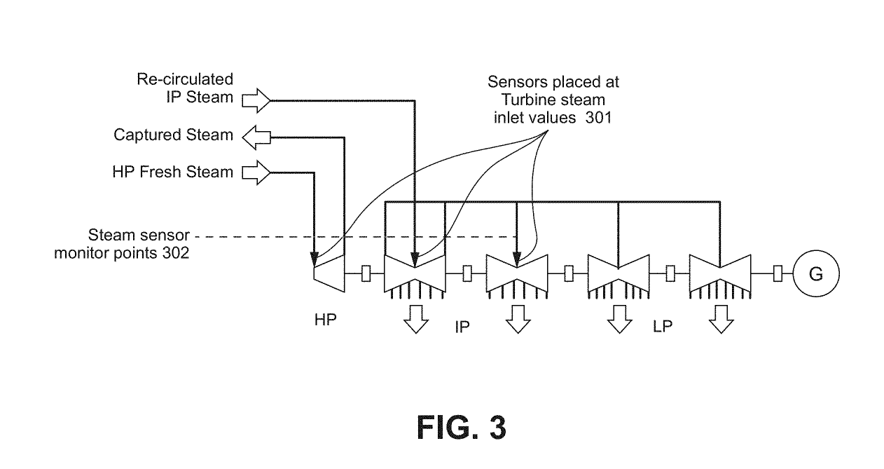

In one example implementation, turbine operational condition sensors 260 are steam conductivity sensors positioned in the steam lines provided to different steam pressure sections of the turbine (e.g., the HP and IP turbine sections). FIG. 3 shows a schematic diagram of a steam turbine 300 under service which illustrates an example placement of steam conductivity sensors 260 as being located in the steam lines just upstream of the steam inlet valves 301. The use of steam conductivity sensors at these sites provides signals indicative of the cation conductivity of the steam provided at the different steam pressure stages of turbine 10. Alternatively, degassed cation conductivity analyzers may be used advantageously at these sights for increased accuracy. The primary distinction between using degassed cation conductivity and cation conductivity is the contribution of CO2 gas conductivity to the cation conductivity signal values.

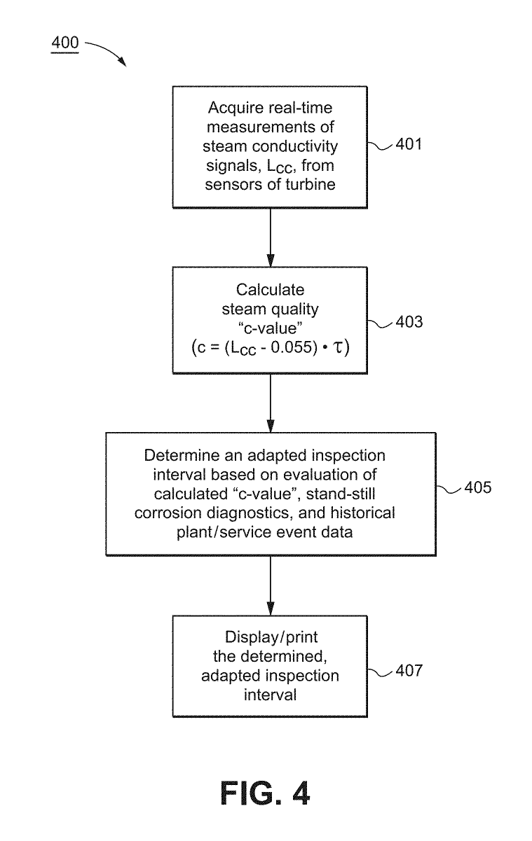

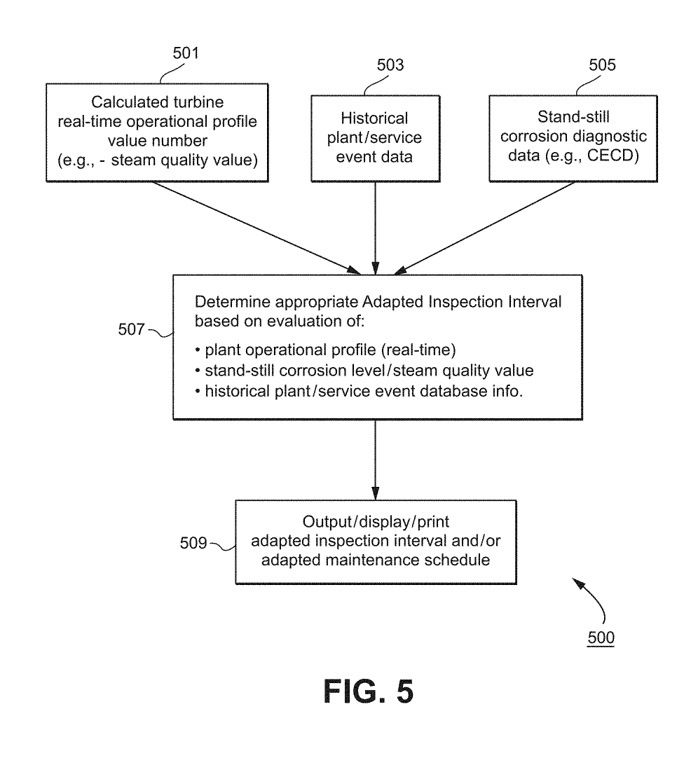

Referring again to FIG. 2, processor 220 is also configured to determine a steam quality value, represented by block 271, based upon signals acquired from one or more of the steam conductivity sensors 260. For the above example, processor 220 receives real time steam conductivity signals from sensors 260 and is configured to calculate a “salt-impact number” or “C-value” that is indicative of accumulated impurities per year passing through the turbine with the steam, and thus the general condition or quality of the steam used at the plant throughout the year for operating that particular turbine. This calculated steam quality value is then used by processor 220 in determining a specific adapted inspection/maintenance interval for the steam turbine, as described in greater detail with reference to FIGS. 4 and 5 below.

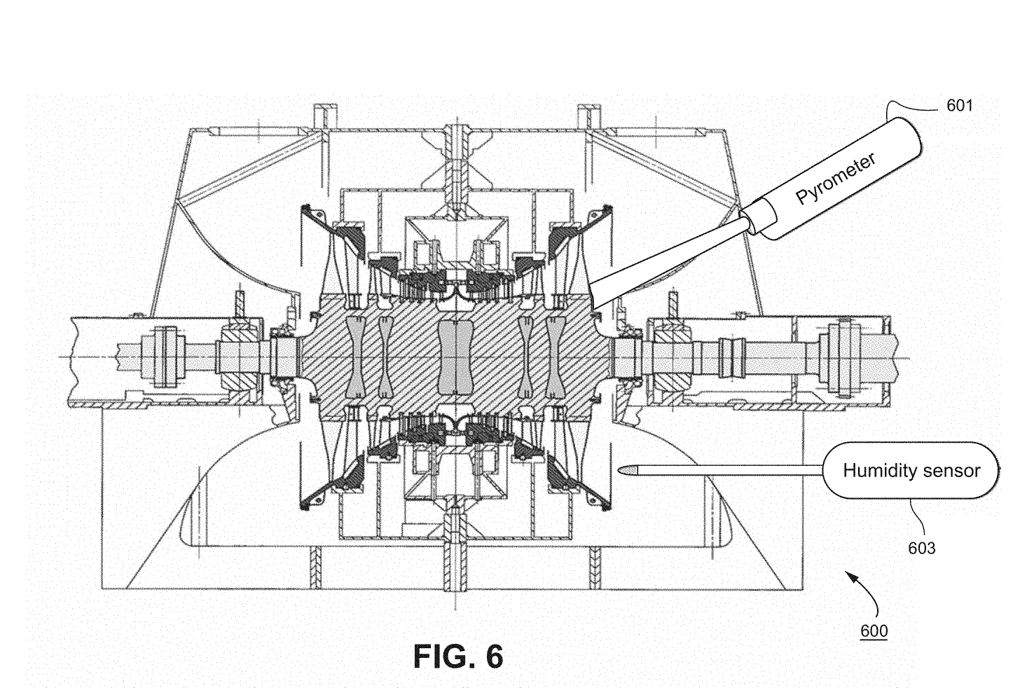

In addition to the monitoring of a best steam quality during operation of a particular steam turbine in service at a plant, other operational conditions at the same plant may also be monitored and used in developing the adapted inspection interval for the turbine such as, for example, the best practice preservation conditions occurring during turbine stand-still or lay-up times. Referring again to FIG. 2, processor 220 is further configured to receive and store relevant turbine corrosion diagnostics data, represented at block 270, acquired during such stand-still or lay-up times. Such corrosion diagnostic data may be acquired, for example, through use of a Cold-End-Corrosion-Diagnostics (CECD) system or the like, which is described herein in greater detail with reference to FIG. 6 further below.

Referring again to FIG. 2, processor 220 is also configured to evaluate the calculated steam quality information/value 271 along with the historical plant/service event information 240 and/or any obtained corrosion diagnostics information 270 to develop an adapted inspection/maintenance interval, as represented by functional block 299. Alternatively, processor 220 may be configured to use only steam quality information or some alternative operational parameter of the turbine monitored at the plant to develop an adapted inspection/maintenance interval. Processor 220 is also configured to print or display the developed adapted inspection/maintenance interval information via terminal/display device 280 of the system 200. The I/O terminal device 280 also enables an operator/user to input system control commands and data to the processor 220 and may include any structure for providing an interface between the user and the system 200. For example, the I/O terminal device 280 may include a keyboard, computer, display, printer, tape drive, and/or any other device for receiving input and providing output to a user.

FIG. 4 illustrates an example processing flow chart 400 implemented by processor 220 for calculating a steam quality “C-value” (salt-impact number) and determining an adapted inspection interval in accordance with one non-limiting example embodiment of the present invention. Initially, in block 401, real-time measurements of steam conductivity, Lcc, are obtained from sensors at the turbine. Next, at block 403, a steam quality “C-value” is calculated by processor 220 using the following formula:

C=(Lcc−0.055)*τ [μS*h/cm*a] EQU. 1

where Lcc is a value for the measured cation conductivity (μS/cm) over a period τ of operational hours per annum (h/a).

The above steam quality “C-value” is based upon a cation conductivity measurement, Lcc, of the steam provided to drive the turbine. Cation conductivity (μS/cm) (as well as degassed cation conductivity) is a standard measure for the sum of all dissociated substances (e.g., salts, acids, bases and some organic substances) in liquids and is an actual substitute for a value of the total dissolved solids/matter (TDS), particularly where the TDS is less than 1 mg/liter. Since the conductivity of “pure” water at 25° C. is approximately 0.055 μS/cm, this value for pure water conductivity must first be subtracted from the measured cation conductivity, Lcc. Every measurement of conductivity of the steam above this particular pure water conductivity value indicates that the steam carries some impurities that may cause degradation, ageing or corrosion of the turbine. Theoretically, a permissible maximum cation conductivity for the steam for a “continuous normal operation” of a steam turbine is Lcc=0.2 μS/cm (where “continuous normal operation” is defined as a base load operation of, for example, 7500 total hours per year for a single turbine at a plant). However, a best and safer practice is to set an Lcc level for the steam that is less than 60% of this theoretical maximum limit. Accordingly, applying this “best practice” approach would require having a measured Lcc of: 0.2 μS/cm*60%=0.12 μS/cm or less. In other words, a steam cation conductivity of 0.12 μS/cm or less would be a fairly good operational value of cation conductivity (Lcc) to maintain during a continuous normal operation of the turbine.

Using the “best practice” value of 0.12 μS/cm for cation conductivity in Equ. 1 above results in a steam quality “C-value” of C=900 μS*h/(cm*a) for a normal continuously run turbine (i.e., approx. 7500 total hours per year operation). It should be noted that if a plant is running a steam turbine for shorter than this example “base load” hours of operation, the above calculated C-value would need to be normalized accordingly. Specifically, the calculated C-value would need to be divided by 7500 hours/year and then multiplied by the actual operational hours for that particular year. For Example, for a plant running only 4560 hours/year, using C=900 μS*h/(cm*a), then C(normalized)=900/7500*4560=547.2 μS*h/(cm*a).

As indicated at block 405 of FIG. 4, an adapted inspection interval is determined based on an evaluation of the calculated “C-value” along with other operation condition data, such as stand-still corrosion diagnostic data, and relevant historical plant/service event data. As represented by evaluation process block 299 in FIG. 2, processor 220 is configured to perform, for example, a simple weighted factor type evaluation based on the calculated C-value and other data or alternatively may be configured to apply a Bayesian inference, a Markov chain Monte Carlo (MCMC) simulation, a stochastic modeling technique or some other predetermined evaluation process for considering the calculated steam quality C-value 271 either alone or together along with acquired plant/service event data 240 and turbine corrosion diagnostics data 270. The adapted inspection interval developed at evaluation process block 405 is preferably based on a prescribed fleet inspection interval for the particular steam turbine used, although not limited to that interval. The resultant adapted inspection interval as determined by processor 220 at evaluation process block 405 may be shorter or longer than the prescribed inspection interval depending on the calculated C-value and other data chosen to be evaluated. The actual time interval or period until next inspection as determined by processor 220 at evaluation process block 405 will also be dependent upon the specific evaluation process chosen as well as the calculated C-value and particular turbine model. The present invention is not intended to be limited to any particular or specific evaluation process 405 that takes into consideration at least a steam quality value or other operational quality assessment value used either alone or together along with acquired plant/service event database information and/or other turbine corrosion diagnostics data.

Ultimately, as indicated at block 407, processor 220 utilizes an I/O device 280 to provide a displayed or printed output of the adapted inspection interval or an inspection schedule based on the adapted interval.

FIG. 5 is a functional block diagram 500 of the method for developing an adapted inspection interval of a steam turbine in accordance with one non-limiting example embodiment of the present invention. It illustrates the basic functional aspects of one preferred method for developing an adapted inspection interval for an individual steam turbine at a particular plant. For example, block 501 represents an operational profile value for a particular turbine operating at a particular plant which is developed based on one or more actual real-time operational conditions of the turbine at that plant such as, for example, a numerical value indicative of the steam quality provided to the turbine over a predetermined period of operation. Block 503 represents historical plant/service event data or other relevant historical operation and maintenance information concerning the same turbine and block 505 represents any corrosion data known or learned about the turbine from diagnostics performed during turbine stand-still or inoperative periods such as, for example, a Cold End Corrosion Diagnostic (CECD) or the like. As illustrated at block 507, an evaluation of the data represented at each of blocks 501, 503 and 505 is performed to determine an appropriate new/updated inspection interval or a modification of a prescribed fleet model inspection interval. The evaluation process may involve using a simple predetermined weighted factor for the data from each source 501, 503 and 505 or may involve using some other modeling technique, as previously mentioned herein above. Ultimately, as indicated at block 509, an adapted inspection interval and/or a maintenance schedule based on the adapted interval is provided via print or display to the plant operator.

Environmental factors such temperature and humidity at a plant can have a significant impact on a steam turbine during extended times of shut-down and non-operation of the turbine. If appropriate preservation measures are not taken during such turbine lay-up or stand-still outage times, premature ageing, degradation and corrosion of the turbine parts can occur. Consequently, good preservation practices during such outage times should be taken and may also be used as a basis for extending the prescribed interval for inspections. One example system that can be used to monitor the best practice preservation measures taken for a given turbine during lay-up or stand-still times is a Cold-End Corrosion Diagnostic (CECD) system. Such a system uses one or more sensors placed in the “cold-end” low pressure steam (LP) section of a turbine to monitor temperature and humidity conditions over time during the lay-up or stand-still periods. FIG. 6 illustrates a schematic diagram of the low pressure steam end section of a steam turbine and depicts example temperature sensor and humidity sensor placements for an example CECD system 600. In the FIG. 6 example CECD system 600, a photo-pyrometer temperature sensor 601 is used to monitor surface temperature of turbine blades and an electronic humidity sensor 603 is used to monitor the relative humidity within the turbine at or near the turbine blades. In this example, the data produced over time by sensors 601 and 603 is recorded and provided to processor 220 for use in determining the adapted inspection interval.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A system for monitoring operating conditions of a steam turbine in service at a particular plant and developing an adaptive inspection interval for the steam turbine, comprising:
a memory element containing an information database relating to use and operation of comparable steam turbines and plant/service events;
an input device, wherein the input device is configured to acquire real-time operational parameter information from the steam turbine in service;
a processor in communication with the memory element and the input device, wherein the processor is configured to calculate an operational quality value for the steam turbine based on the acquired real-time operational parameter information and then determine an adapted inspection interval based at least upon the calculated operational quality value; and
wherein the processor is configured to generate at least one of an inspection interval or maintenance scheduling information.

2. The system as in claim 1, wherein the real-time operational parameter information from the steam turbine in service comprises steam conductivity signals obtained from one or more sensors monitoring steam supplied to the turbine.

3. The system as in claim 1, wherein the processor is configured to calculate a steam quality value as the operational quality value.

4. The system as in claim 3, wherein the processor is configured to calculate the steam quality value in accordance with the following relationship:
C(steam quality value)=(Lcc−0.055)*τ [μS*h/cm*a]
where Lcc is measured steam cation conductivity (μS/cm) obtained from sensors at the turbine over a period τ of operational hours per annum (h/a).

5. The system as in claim 1, wherein the processor is configured to determine the adapted inspection interval based upon the calculated operational quality value considered along with information obtained from the information database.

6. The system as in claim 1, wherein the processor is configured to determine the adapted inspection interval based upon the calculated operational quality value considered along with stand-still corrosion diagnostic data relating to the steam turbine.

7. The system as in claim 1, wherein the information database includes historical plant/service event data and/or information operational parameter information reflecting comparable steam turbines at other plants.

8. The system as in claim 1, further comprising a fleet model in the information database, wherein the fleet model includes parameter information from comparable steam turbines.

9. The system as in claim 1, wherein the information database includes data of comparable steam turbines reflecting one or more of inspection intervals, operation, repairs, or maintenance of comparable steam turbines.

10. A computer-implemented method for monitoring operating conditions of a steam turbine in service at a particular plant and developing an adaptive inspection interval for the steam turbine, comprising:
receiving in a computing device real-time operational parameter information of the steam turbine in service;
calculating, using the computing device, an operational quality value for the steam turbine based on the acquired real-time operational parameter information;
processing, using the computing device, at least the calculated operational quality value to determine an adapted inspection interval; and
generating an output using the computing device, wherein the output contains at least one of an inspection interval or maintenance scheduling information.

11. The method of claim 10, wherein the computing device is configured to receive operational condition information from an information database containing information reflecting use and operation of comparable steam turbines and plant/service events.

12. The method of claim 10, wherein the real-time operational parameter information from the steam turbine in service comprises steam conductivity signals obtained from one or more sensors monitoring steam supplied to the turbine.

13. The method of claim 10, wherein the computing device is configured to calculate a steam quality value as the operational quality value.

14. The method of claim 10, wherein the computing device is configured to calculate the steam quality value in accordance with the following relationship:
C(steam quality value)=(Lcc−0.055)*τ [μS*h/cm*a]
where Lcc is measured steam cation conductivity (μS/cm) obtained from sensors at the turbine over a period τ of operational hours per annum (h/a).

15. The method of claim 10, wherein the computing device is configured to determine the adapted inspection interval based upon the calculated operational quality value considered along with information obtained from the information database.

16. The method of claim 10, wherein the computing device is configured to determine the adapted inspection interval based upon the calculated operational quality value considered along with stand-still corrosion diagnostic data relating to the steam turbine.

17. The method of claim 11, wherein the information database includes historical plant/service event data and/or information operational parameter information reflecting comparable steam turbines at other plants.

18. The method of claim 11, further comprising a fleet model in the information database, wherein the fleet model includes parameter information from comparable steam turbines.

19. The method of claim 11, wherein the information database includes data of comparable steam turbines reflecting one or more of inspection intervals, operation, repairs, or maintenance of comparable steam turbines.

20. A method for monitoring operating conditions of a steam turbine in service at a particular plant and developing an adaptive inspection interval for the steam turbine, comprising:
receiving in a computing device real-time operational parameter information indicative of steam cation conductivity of steam provided to the steam turbine in service;
calculating, using the computing device, a steam quality value for the steam turbine based on the acquired real-time operational parameter information;
processing, using the computing device, at least the calculated operational quality value to determine an adapted inspection interval; and
generating an output using the computing device, wherein the output contains at least one of an inspection interval or maintenance scheduling information.
